(19) United States
(12) Patent Application Publication
(10) Pub. No.: US 2026/0303317 A1
(43) Pub. Date: Oct. 1, 2026

(54) TRANSMISSION DEVICE, TRANSMISSION METHOD, RECEPTION DEVICE, AND RECEPTION METHOD

(71) Applicant: SONY SEMICONDUCTOR SOLUTIONS CORPORATION, KANAGAWA (JP)

(72) Inventor: YUYA SATO, KANAGAWA (JP)

(21) Appl. No.: 19/164,240

(22) PCT Filed: Mar. 7, 2024
(86) PCT No.: PCT/JP2024/008689

§ 371 Date: Sep. 11, 2025

(30) Foreign Application Priority Data
Mar. 30, 2023 (JP) 2023-055662

(51) Int. Cl. H04L 7/00

(52) U.S. Cl. CPC H04L 7/0091

(57) ABSTRACT

The present disclosure relates to a transmission device, a transmission method, a reception device, and a reception method that make it possible to detect frame positions more favorably. A modulation signal generation section generates a complex modulation signal including a synchronization sequence; a CW signal generation section generates a complex CW signal having any frequency; a frame generation section generates a time synchronization frame for time synchronization with a reception device by superimposing the complex CW signal on the complex modulation signal; and a transmission section transmits the time synchronization frame to the reception device as a transmission signal. The technology according to the present disclosure is applicable to wireless communication systems for which the time synchronization is necessary.

### TECHNICAL FIELD

The present disclosure relates to a transmission device, a transmission method, a reception device, and a reception method, and more particularly, to a transmission device, a transmission method, a reception device, and a reception method that make it possible to detect frame positions more favorably.

### BACKGROUND ART

In ELTRES (registered trademark) that is one of low-power wide area (LPWA) communications standards, base stations and terminals achieve time synchronization by using a global navigation satellite system (GNSS) to transmit/receive data frames to/from each other. The time synchronization using the GNSS has problems such as high power consumption, slow synchronization in certain conditions, inability to achieve synchronization indoors, and similar challenges.

On the other hand, it is common practice to insert a synchronization signal into a head or middle of a frame in a case of transmitting/receiving a data frame in wireless communication. One of technologies of estimating a frame position of the synchronization signal includes a preamble scheme. In the preamble scheme, a transmitter transmits a modulation signal including a synchronization sequence, and a receiver detects a frame position through correlation calculation of a reception signal and known synchronization sequences.

However, if attempting to achieve communication performance required by the ELTRES (registered trademark) while using the preamble scheme, this requires a large amount of throughput and terminals on the receiver side need many arithmetic circuits.

Patent Literature 1 discloses a method of generating a transmission signal by allocating a modulation signal and a narrowband synchronization signal to two different axes in a complex signal space, as a transmission signal for estimating a frame position.

### CITATION LIST

### Patent Literature

Patent Literature 1: WO 2021/245718

### DISCLOSURE OF INVENTION

### Technical Problem

The method disclosed in Patent Literature 1 uses two side carrier signals as the narrowband synchronization signal, and this makes it possible to allocate transmission power to halves. Therefore, if performing an FFT on a signal received by the receiver to detect a peak of the narrowband synchronization signal, this deteriorates its noise resistance due to the halved transmission power. As a result, it may become impossible to detect the frame position appropriately.

The present technology is made in view of the above described situation, and it is intended to detect frame positions more favorably.

### Solution to Problem

A transmission device according to a first aspect of the present disclosure is a transmission device including a modulation signal generation section that generates a complex modulation signal including a synchronization sequence; a CW signal generation section that generates a complex CW signal having any frequency; a frame generation section that generates a time synchronization frame for time synchronization with a reception device by superimposing the complex CW signal on the complex modulation signal; and a transmission section that transmits the time synchronization frame to the reception device as a transmission signal.

A transmission method according to the first aspect of the present disclosure is a transmission method that is performed by a transmission device, the transmission method including generating a complex modulation signal including a synchronization sequence; generating a complex CW signal having any frequency; generating a time synchronization frame for time synchronization with a reception device by superimposing the complex CW signal on the complex modulation signal; and transmitting the time synchronization frame to the reception device as a transmission signal.

A reception device according to a second aspect of the present disclosure is a reception device including a frame position detection section that detects a frame position of a time synchronization frame by detecting a frequency peak of a complex CW signal having any frequency through frequency analysis on a transmission signal from a transmission device that generates the time synchronization frame by superimposing the complex CW signal on a complex modulation signal including a synchronization sequence.

A reception method according to the second aspect of the present disclosure is a reception method that is performed by a reception device, the reception method including detecting a frame position of a time synchronization frame by detecting a frequency peak of a complex CW signal having any frequency through frequency analysis on a transmission signal from a transmission device that generates the time synchronization frame by superimposing the complex CW signal on a complex modulation signal including a synchronization sequence.

According to the first aspect of the present disclosure, a complex modulation signal including a synchronization sequence is generated; a complex CW signal having any frequency is generated; a time synchronization frame for time synchronization with a reception device is generated by superimposing the complex CW signal on the complex modulation signal; and the time synchronization frame is transmitted to the reception device as a transmission signal.

According to the second aspect of the present disclosure, a frame position of a time synchronization frame is detected by detecting a frequency peak of a complex CW signal having any frequency through frequency analysis on a transmission signal from a transmission device that generates the time synchronization frame by superimposing the complex CW signal on a complex modulation signal including a synchronization sequence.

### BRIEF DESCRIPTION OF DRAWINGS

FIG. 1 is a diagram illustrating a configuration example of a wireless communication system to which the technology according to the present disclosure can be applied.

FIG. 2 is a block diagram illustrating a configuration example of a transmission device.

FIG. 3 is a flowchart for describing a time synchronization frame generation process.

FIG. 4 is a diagram for describing a configuration of a transmission signal.

FIG. 5 is a block diagram illustrating a configuration example of a reception device.

FIG. 6 is a flowchart for describing a frame position detection process.

### MODE(S) FOR CARRYING OUT THE INVENTION

Hereinafter, modes (hereafter, referred to as “embodiments”) for carrying out the technology according to the present disclosure will be described. Note that the description will be given in the following order.
1. Related art and its problems
2. Configuration example of wireless communication system
3. Configuration and behavior of transmission device
4. Configuration and behavior of reception device
5. Application examples

### 1. Related art and its Problems

In ELTRES (registered trademark) that is one of low-power wide area (LPWA) communications standards, base stations and terminals achieve time synchronization by using a global navigation satellite system (GNSS) to transmit/receive data frames to/from each other. The time synchronization using the GNSS has problems such as high power consumption, slow synchronization in certain conditions, inability to achieve synchronization indoors, and similar challenges.

To handle this problem, it is conceivable that synchronization is achieved by transmitting a time synchronization frame from a base station to a terminal.

It is common practice to insert a synchronization signal into a head or middle of a frame in a case of transmitting/receiving a data frame in wireless communication.

One of technologies of estimating a frame position of the synchronization signal includes the preamble scheme. In the preamble scheme, a transmitter transmits a modulation signal including a synchronization sequence, and a receiver detects a frame position through correlation calculation of a reception signal and known synchronization sequences.

Data frames of ELTRES (registered trademark) has high sensitivity performance and high resistance to jamming waves. The time synchronization frame is also required to have communication performance that is equal to or higher than those of the data frames. However, if attempting to achieve the communication performance required by the ELTRES (registered trademark) while using the preamble scheme, this requires a large amount of throughput and terminals on the receiver side need many arithmetic circuits.

According to the technology of the present disclosure, a frame is generated as the time synchronization frame by superimposing a complex CW signal having any frequency on a complex modulation signal including a synchronization sequence. This makes it possible to achieve high communication performance and a reception process with low throughput.

### 2. Configuration Example of Wireless Communication System

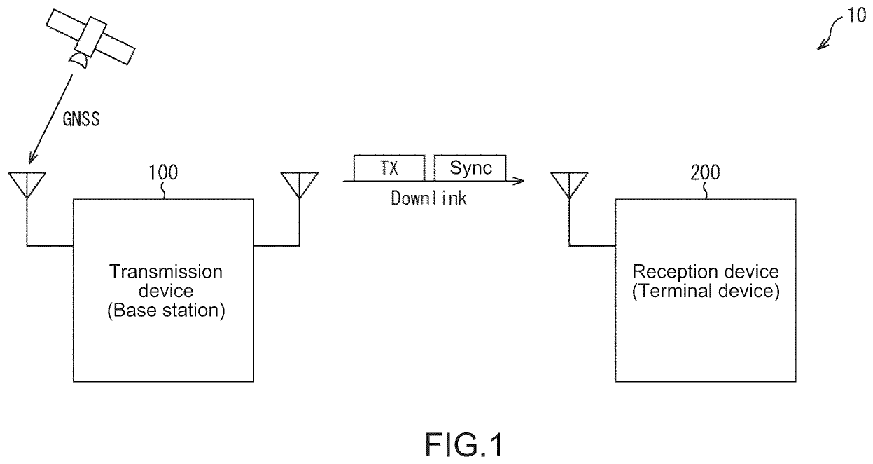

FIG. 1 is a diagram illustrating a configuration example of a wireless communication system to which the technology according to the present disclosure can be applied.

In a wireless communication system 10 illustrated in FIG. 1, a transmission device 100 serving as a base station and a reception device 200 serving as a terminal device transmit/receive a data frame through ELTRES (registered trademark) that is one of the LPWA communication standards.

The transmission device 100 acquires time information by receiving a GNSS signal from a GNSS satellite. The transmission device 100 transmits a time synchronization frame based on the time information to the reception device 200 through a downlink. The reception device 200 performs time synchronization with the transmission device 100 by using the time synchronization frame transmitted from the transmission device 100.

The configuration of the wireless communication system makes it possible to achieve the time synchronization by using the downlink without using GNSS. This enables the time synchronization indoors and semi-indoors. Also, it is not necessary to install a GNSS chip in a communication module of the reception device 200, and this reduces the cost of the communication modules.

Next, detailed configurations and behavior of the transmission device 100 and the reception device 200 will be described.

### 3. Configuration and Behavior of Transmission Device

### (Configuration of Transmission Device)

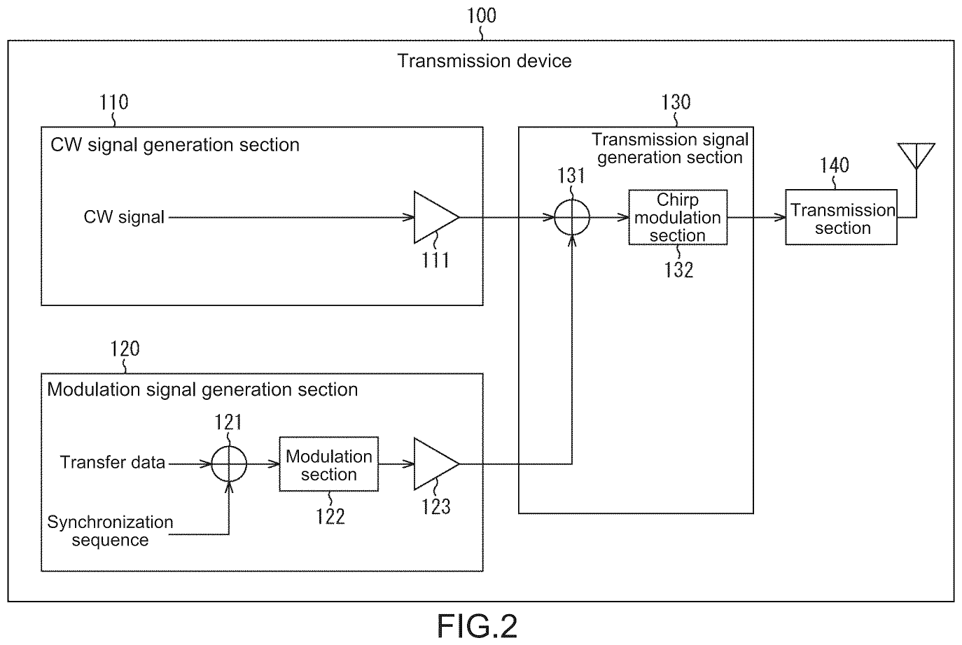

FIG. 2 is a block diagram illustrating a configuration example of the transmission device 100.

As illustrated in FIG. 2, the transmission device 100 includes a CW signal generation section 110, a modulation signal generation section 120, a transmission signal generation section 130, and a transmission section 140.

The CW signal generation section 110 generates a complex continuous wave (CW) signal that is a complex sine wave having any frequency.

For example, the complex CW signal has a frequency of 0 Hz (DC component only). However, the complex CW signal may have any frequency in a range which does not depart from the object of the technology according to the present disclosure. The CW signal generation section 110 includes an amplifier 111 to supply the complex CW signal to the transmission signal generation section 130 after multiplying the amplitude of the complex CW signal by a predetermined multiplier as necessary.

The modulation signal generation section120 generates a complex modulation signal including a synchronization sequence and transfer data.

The modulation signal generation section 120 includes an adder 121 to generate modulation data in which the synchronization sequence (synchronization signal) generated using pseudorandom numbers is evenly distributed in a frame included in the transfer data. The modulation signal generation section 120 also includes a modulation section 122 to generate the complex modulation signal by performing π/2 binary phase-shift keying (BPSK) modulation on the modulation data generated by the adder 121. The π/2 BPSK modulation is one of phase-shift keying modulation. The modulation signal generation section 120 also includes an amplifier 123 to supply the complex CW signal to the transmission signal generation section 130 after multiplying the amplitude of the complex CW signal by a predetermined multiplier as necessary.

The complex modulation signal generated by the modulation signal generation section 120 may include the synchronization sequence only, or may include the synchronization sequence and other data sequence such as the transfer data. In addition, the modulation method of the complex modulation signal is not limited to the π/2 BPSK modulation, but it is possible to adopt any other modulation methods in a range which does not depart from the object of the technology according to the present disclosure.

The transmission signal generation section 130 functions as a frame generation section that generates a time synchronization frame for time synchronization with the reception device 200 by superimposing the complex CW signal from the CW signal generation section 110 on the complex modulation signal from the modulation signal generation section 120.

The transmission signal generation section 130 includes a superposition section 131 to superimpose the complex CW signal on the complex modulation signal. The transmission signal generation section 130 generates the time synchronization frame by superimposing a carrier signal on the complex modulation signal on which the complex CW signal has been superimposed. Specifically, a chirp modulation section 132 performs a chirp modulation process by using a chirp signal as the carrier signal. The chirp signal changes its center frequency linearly with elapsed time of the frame. Next, as the transmission signal, the transmission signal generation section 130 supplies the transmission section 140 with the time synchronization frame subjected to the chirp modulation process.

The transmission section 140 appropriately amplifies the transmission signal from the transmission signal generation section 130, and transmits it to the reception device 200.

### (Behavior of Transmission Device)

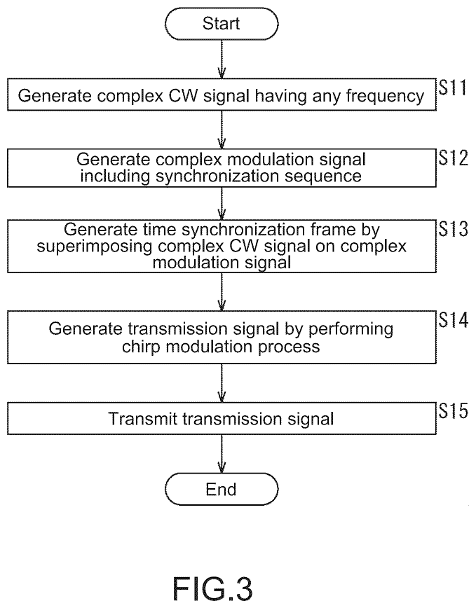

With reference to FIG. 3, the time synchronization frame generation process executed by the transmission device 100 will be described.

In Step S11, the CW signal generation section 110 generates a complex CW signal having any frequency.

In Step S12, the modulation signal generation section 120 generates a complex modulation signal including a synchronization sequence.

In Step S13, the transmission signal generation section 130 (superimposition section 131) generates a time synchronization frame by superimposing the complex CW signal generated by the CW signal generation section 110 on the complex modulation signal generated by the modulation signal generation section 120. At this time, the complex CW signal and the complex modulation signal are both complex signals. Therefore, a complex CW signal component in the time synchronization frame is a very narrow signal component.

In Step S14, the transmission signal generation section 130 (chirp modulation section 132) generates a transmission signal by performing the chirp modulation process on the complex modulation signal on which the complex CW signal has been superimposed.

In Step S15, the transmission section 140 transmits the transmission signal generated by the transmission signal generation section 130.

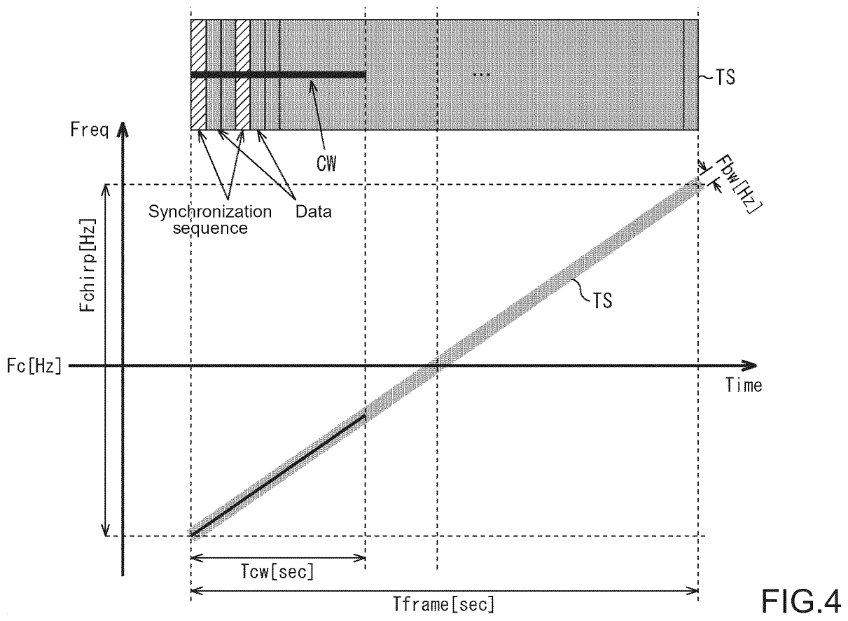

Next, with reference to FIG. 4, a configuration of the transmission signal will be described.

FIG. 4 illustrates a time synchronization frame TS serving as the transmission signal subjected to the chirp modulation. Fc [Hz] represents its center frequency, Tframe [sec] represents its frame period, Fchirp [Hz] represents its chirp width, and Fbw [Hz] represents its bandwidth. The time synchronization frame TS is configured to achieve its center frequency Fc at the middle of its frame period Tframe.

In the time synchronization frame TS, the complex CW signal is superimposed on the complex modulation signal in which the synchronization sequence (synchronization signal) generated using pseudorandom numbers is evenly distributed in the frame included in the transfer data. As described above, the complex CW signal and the complex modulation signal are both complex signals. Therefore, as illustrated in FIG. 4, transmission power of the complex CW signal component (CW) in the time synchronization frame TS is concentrated in a specific frequency.

In addition, it is sufficient for the complex CW signal to be superimposed on (combined with) at least any portion of a time domain of the frame period Tframe of the complex modulation signal in a range which does not depart from the object of the technology according to the present disclosure. In other words, the complex CW signal may be combined with respect to the whole or a portion of the time domain of the frame period Tframe of the complex modulation signal. In FIG. 4, the complex CW signal is combined with respect to a time domain of a period Tcw [sec] starting from the head of the time synchronization frame TS.

In addition, the complex CW signal may be combined regardless of the phase of the complex modulation signal. In other words, it is not necessary to match the complex CW signal to the phase of the complex modulation signal when superimposing the complex CW signal on the complex modulation signal.

According to the above-described configurations and process, the time synchronization frame is generated by superimposing the complex CW signal having any frequency on the complex modulation signal including the synchronization sequence. Therefore, the time synchronization frame includes a narrowband synchronization signal whose transmission power is concentrated in one narrow band. Specifically, it is possible to improve its performance by about 3 dB in comparison with the side carrier signals disclosed in Patent Literature 1. This makes it possible to improve noise immunity when performing an FFT on a signal received by the receiver and detecting a peak of the narrowband synchronization signal. Accordingly, this allows the receiver to detect frame positions more favorably as will be described later while achieving high communication performance.

### 4. Configuration and Behavior of Reception Device

### (Configuration of Reception Device)

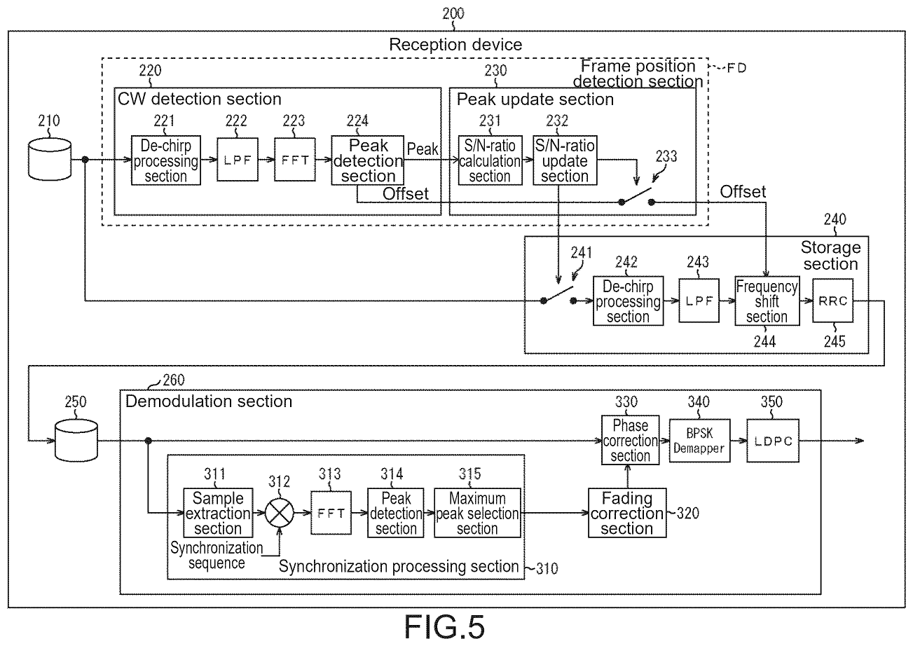

FIG. 5 is a block diagram illustrating a configuration example of the reception device 200.

In FIG. 5, components of the reception device 200 before conversion of received radio waves into a digital I/Q signal are omitted. Therefore, as illustrated in FIG. 5, the reception device 200 includes a first buffer 210, a CW detection section 220, a peak update section 230, a storage section 240, a second buffer 250, and a demodulation section 260.

The first buffer 210 stores the digital I/Q signal (transmission signal from transmission device 100) as an input signal. The digital I/Q signal is obtained by converting the radio waves received by the reception device 200.

The CW detection section 220 detects a frequency peak of the complex CW signal from the input signal of the first buffer 210.

In the CW detection section 220, a de-chirp processing section 221 performs a de-chirp process on the input signal of the first buffer 210 at regular time intervals, and a low-pass filter (LPF) 222 eliminates high-frequency components. A fast Fourier transform (FFT) section 223 performs an FFT on the signal from which the high-frequency components are eliminated, and a peak detection section 224 detects a frequency peak of the complex CW signal. The detected frequency peak and a frequency offset included in the input signal is supplied to the peak update section 230.

The peak update section 230 updates a maximum value of frequency peaks of the complex CW signal, on the basis of the frequency peaks detected by the CW detection section 220 at regular time intervals.

In the peak update section 230, an S/N-ratio calculation section 231 calculates an S/N ratio of a result of analysis performed through the FFT on the basis of the frequency peak obtained from the CW detection section 220, and an S/N-ratio update section 232 updates the maximum value of the frequency peaks on the basis of the calculated S/N ratio. When a switch 233 is turned on through the update of the maximum value of the frequency peaks by the S/N-ratio update section 232, the CW detection section 220 supplies the frequency offset to the storage section 240.

As described above, the CW detection section 220 and the peak update section 230 form a frame position detection section FD that detects the frame position of the time synchronization frame by detecting the frequency peak of the complex CW signal through frequency analysis on the transmission signal from the transmission device 100. This makes it possible to roughly detect the frame position of the time synchronization frame of the transmission signal from the transmission device 100.

The storage section 240 stores the input signal obtained when the frequency peak of the complex CW signal is detected, into the second buffer 250.

When a switch 241 in the storage section 240 is turned on through the update of the maximum value of the frequency peaks by the peak update section 230, the first buffer 210 supplies the input signal to a de-chirp processing section 242. The de-chirp processing section 242 performs a de-chirp process on the input signal at regular time intervals, and an LPF 223 eliminates high-frequency components. A frequency shift section 244 corrects the frequency offset obtained from the CW detection section 220 with regard to the signal from which the high-frequency components have been eliminated. A root-raised-cosine (RRC) filter 245 constrains intersymbol interference of the signal whose frequency offset has been corrected and supplies it to the second buffer 250.

The demodulation section 260 performs a process of time synchronization with the transmission device 100 and a demodulation process of the transfer data by using the input signal that has been obtained when the frequency peak of the complex CW signal has been detected and that has been stored in the second buffer 250.

The demodulation section 260 includes a synchronization processing section 310, a fading correction section 320, a phase correction section 330, a BPSK demapper 340, and a low-density parity-check (LDPC) section 350.

The synchronization processing section 310 performs a process of time synchronization with the transmission device 100 through correlation calculation using the synchronization sequence included in the input signal (transmission signal) that has been obtained when the frequency peak of the complex CW signal has been detected and that has been stored in the second buffer 250.

In the synchronization processing section 310, a sample extraction section 311 extracts, while shifting by sample time, the input signal that has been obtained when the frequency peak of the complex CW signal has been detected, and a correlation calculation section 312 calculates cross-correlation with previously known synchronization sequences. An FFT section 313 performs the FFT on correlation values obtained through the calculation. A peak search section 314 search results of analysis using the FFT for peak values. The maximum peak selection section 315 selects a maximum value of the peak values. This makes it possible to accurately detect the frame position of the time synchronization frame of the transmission signal from the transmission device 100.

Then, the fading correction section 320 calculates an amount of correction of frequency characteristic distortion caused by fading, on the basis of the result of analysis performed by the synchronization processing section 310 using the FFT. The phase correction section 330 corrects phase rotation of the input signal (digital I/Q signal) stored in the second buffer, on the basis of the amount of correction calculated by the fading correction section 320.

The BPSK demapper 340 performs BPSK demodulation by demapping the input signal whose phase rotation is corrected.

The LDPC section 350 uses a low-density parity-check (LDPC) code to perform error correction on the demodulated data subjected to the BPSK demodulation.

(Behavior of reception device)

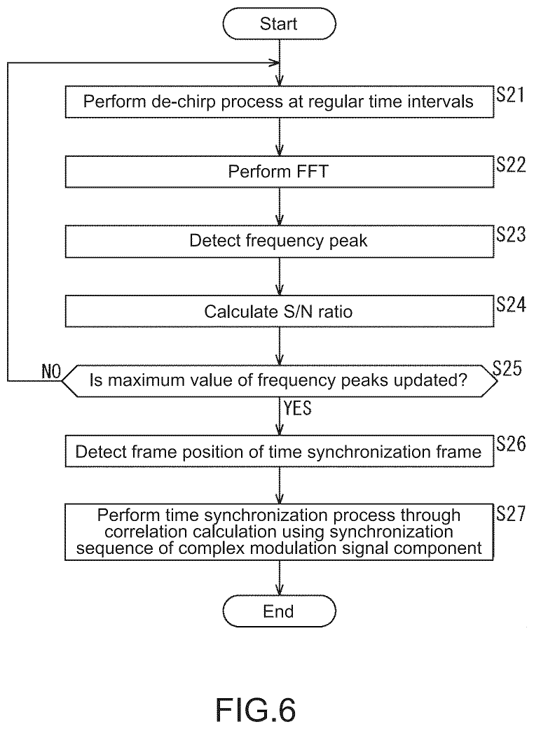

With reference to FIG. 6, the time synchronization frame position detection process executed by the reception device 200 will be described.

The process illustrated in FIG. 6 is started when the first buffer 210 begins to store the digital I/Q signal (input signal) obtained by converting radio waves received by the reception device 200, for example.

In Step S21, the CW detection section 220 performs the de-chirp process on the input signal of the first buffer 210 at regular time intervals such as 20 msec.

In Step S22, the CW detection section 220 performs the FFT on the de-chirped signal subjected to the de-chirp process.

In Step S23, the CW detection section 220 detects the frequency peak of the complex CW signal on the basis of a result of the analysis performed through the FFT.

In Step S24, the peak update section 230 calculates an S/N ratio of the result of analysis performed through the FFT, on the basis of the frequency peak detected by the CW detection section 220. As described above, the S/N ratios calculated for the input signals obtained at the regular time intervals are held by memory (not illustrated).

In Step S25, the peak update section 230 determines whether the maximum value of the frequency peaks of the complex CW signal is updated by comparing a calculated S/N ratio with the past S/N ratios held by the memory (not illustrated).

In a case where the maximum value of the frequency peaks is not updated, that is, the calculated S/N ratio is smaller than the past S/N ratios in Step S25, the process returns to Step S21, and then the processes in Steps S21 to S25 are repeated with regard to an input signal obtained in a next time unit (for example, 20 msec).

On the other hand, in a case where it is determined that the maximum value of the frequency peaks is updated, that is, the calculated S/N ratio is larger than the past S/N ratios in Step S25, the process proceeds to Step S26.

In Step S26, the peak update section 230 detects a frame position of the input signal obtained when the maximum value of the frequency peaks of the complex CW signal is updated, as a frame position of the time synchronization frame. This makes it possible to roughly detect the frame position of the time synchronization frame of the transmission signal from the transmission device 100.

Next, in Step S27, the synchronization processing section 310 performs the time synchronization process through the correlation calculation using the synchronization sequence included in a complex modulation signal component of the input signal that has been obtained when the frame position of the time synchronization frame has been detected and that has been stored in the second buffer 250. This makes it possible to accurately detect the frame position of the time synchronization frame of the transmission signal from the transmission device 100.

The above-described processes makes it possible to roughly detect the frame position of the time synchronization frame by detecting the frequency peak of the complex CW signal through the FFT performed on the transmission signal from the transmission device 100, even in a situation where the time synchronization is not achieved (a situation where a timing of arrival of the time synchronization frame is unknown). Subsequently, it is possible to accurately detect the frame position of the time synchronization frame through the correlation calculation using the know synchronization sequences and the synchronization sequence included in the complex modulation signal component.

As described above, in the situation where the timing of arrival of the time synchronization frame is unknown, it is possible to reduce a time shift amount when calculating the cross-correlation by detecting the complex CW signal at rough time intervals (for example, 20 msec). This makes it possible to reduce throughput of the reception process.

### 5. Application Examples

The example in which the technology according to the present disclosure is applied to the wireless communication system of transmitting/receiving data frames through ELTRES (registered trademark) has been described above. However, the technology according to the present disclosure is not limited thereto. The technology according to the present disclosure is applicable to cellular communication for which the time synchronization is necessary, wireless communication systems that performs LPWA communication according to other LPWA communication standards, wireless local area networks, and the like.

Embodiments of the present disclosure are not limited to the above described embodiment, and various modifications may be made without departing from the scope of the present disclosure.

Further, the effects described in this specification are merely illustrative or exemplified effects, and are not limitative, and the technology according to the present disclosure may achieve other effects.

Note that, the technology according to the present disclosure may also be configured as below.
(1) A transmission device including:
   a modulation signal generation section that generates a complex modulation signal including a synchronization sequence;
   a CW signal generation section that generates a complex CW signal having any frequency;
   a frame generation section that generates a time synchronization frame for time synchronization with a reception device by superimposing the complex CW signal on the complex modulation signal; and
   a transmission section that transmits the time synchronization frame to the reception device as a transmission signal.
(2) The transmission device according to (1), in which
   the frame generation section combines the complex CW signal with respect to at least any portion of a time domain of a frame period of the complex modulation signal.
(3) The transmission device according to (1) or (2), in which
   the frame generation section combines the complex CW signal regardless of a phase of the complex modulation signal.
(4) The transmission device according to any of (1) to (3), in which
   the modulation signal generation section generates the complex modulation signal further including any transfer data.
(5) The transmission device according to any of (1) to (4), in which
   the frame generation section generates the time synchronization frame by superimposing a carrier signal on the complex modulation signal on which the complex CW signal has been superimposed.
(6) The transmission device according to (5), in which
   the frame generation section uses, as the carrier signal, a chirp signal whose frequency varies with time.
(7) A transmission method that is performed by a transmission device, the transmission method including:
   generating a complex modulation signal including a synchronization sequence;
   generating a complex CW signal having any frequency;
   generating a time synchronization frame for time synchronization with a reception device by superimposing the complex CW signal on the complex modulation signal; and
   transmitting the time synchronization frame to the reception device as a transmission signal.
(8) A reception device including
   a frame position detection section that detects a frame position of a time synchronization frame by detecting a frequency peak of a complex CW signal having any frequency through frequency analysis on a transmission signal from a transmission device that generates the time synchronization frame by superimposing the complex CW signal on a complex modulation signal including a synchronization sequence.
(9) The reception device according to (8), in which
   the frame position detection section detects the time synchronization frame by updating a maximum value of the frequency peaks of the complex CW signal through the frequency analysis performed at regular time intervals.
(10) The reception device according to (9), in which
   the frame position detection section updates the maximum value of the frequency peaks of the complex CW signal on the basis of S/N ratios of analysis results obtained through the frequency analysis performed at the regular time intervals.
(11) The reception device according to any of (8) to (10), further including
   a synchronization processing section that performs a process of time synchronization with the transmission device through correlation calculation using the synchronization sequence included in the transmission signal obtained when the frequency peak of the complex CW signal is detected.
(12) A reception method that is performed by a reception device, the reception method including
   detecting a frame position of a time synchronization frame by detecting a frequency peak of a complex CW signal having any frequency through frequency analysis on a transmission signal from a transmission device that generates the time synchronization frame by superimposing the complex CW signal on a complex modulation signal including a synchronization sequence.

### REFERENCE SIGNS LIST

10 wireless communication system
100 transmission device
110 CW signal generation section
120 modulation signal generation section
130 transmission signal generation section
140 transmission section
200 reception device
220 CW detection section
230 peak update section
FD frame position detection section
240 storage section
260 demodulation section
310 synchronization processing section

1. A transmission device comprising:
a modulation signal generation section that generates a complex modulation signal including a synchronization sequence;
a CW signal generation section that generates a complex CW signal having any frequency;
a frame generation section that generates a time synchronization frame for time synchronization with a reception device by superimposing the complex CW signal on the complex modulation signal; and
a transmission section that transmits the time synchronization frame to the reception device as a transmission signal.

2. The transmission device according to claim 1, wherein
the frame generation section combines the complex CW signal with respect to at least any portion of a time domain of a frame period of the complex modulation signal.

3. The transmission device according to claim 1, wherein
the frame generation section combines the complex CW signal regardless of a phase of the complex modulation signal.

4. The transmission device according to claim 1, wherein
the modulation signal generation section generates the complex modulation signal further including any transfer data.

5. The transmission device according to claim 1, wherein
the frame generation section generates the time synchronization frame by superimposing a carrier signal on the complex modulation signal on which the complex CW signal has been superimposed.

6. The transmission device according to claim 5, wherein
the frame generation section uses, as the carrier signal, a chirp signal whose frequency varies with time.

7. A transmission method that is performed by a transmission device, the transmission method comprising:
generating a complex modulation signal including a synchronization sequence;
generating a complex CW signal having any frequency;
generating a time synchronization frame for time synchronization with a reception device by superimposing the complex CW signal on the complex modulation signal; and
transmitting the time synchronization frame to the reception device as a transmission signal.

8. A reception device comprising
a frame position detection section that detects a frame position of a time synchronization frame by detecting a frequency peak of a complex CW signal having any frequency through frequency analysis on a transmission signal from a transmission device that generates the time synchronization frame by superimposing the complex CW signal on a complex modulation signal including a synchronization sequence.

9. The reception device according to claim 8, wherein
the frame position detection section detects the time synchronization frame by updating a maximum value of the frequency peaks of the complex CW signal through the frequency analysis performed at regular time intervals.

10. The reception device according to claim 9, wherein
the frame position detection section updates the maximum value of the frequency peaks of the complex CW signal on a basis of S/N ratios of analysis results obtained through the frequency analysis performed at the regular time intervals.

11. The reception device according to claim 8, further comprising
a synchronization processing section that performs a process of time synchronization with the transmission device through correlation calculation using the synchronization sequence included in the transmission signal obtained when the frequency peak of the complex CW signal is detected.

12. A reception method that is performed by a reception device, the reception method comprising
detecting a frame position of a time synchronization frame by detecting a frequency peak of a complex CW signal having any frequency through frequency analysis on a transmission signal from a transmission device that generates the time synchronization frame by superimposing the complex CW signal on a complex modulation signal including a synchronization sequence.
